(19) United States
(12) Patent Application Publication
(10) Pub. No.: US 2008/0223031 A1
(43) Pub. Date: Sep. 18, 2008

(54) Crosshead Arrangement

(75) Inventors: Per D. Sollie, Sheffield (GB); Lars Kjosbakken, Sheffield (GB); Sven Erik Fossum, Sheffield (GB); Eldar Onsoyen, Sheffield (GB); Sverre Johansen, Sheffield (GB)

Correspondence Address: CHRISTIAN D. ABEL, ONSAGERS AS, POSTBOKS 6963 ST. OLAVS PLASS, NORWAY, N-0130, NO

(73) Assignee: DISSENCO LIMITED, Sheffield (GB)

(21) Appl. No.: 11/912,505

(22) PCT Filed: Apr. 26, 2006
(86) PCT No.: PCT/GB2006/001513

§ 371 Date: May 22, 2008

(30) Foreign Application Priority Data
Apr. 26, 2005 (GB) 0508446.2

(51) Int. Cl. F01B 9/00; F02G 1/00

(52) U.S. Cl. 60/517; 92/140

(57) ABSTRACT

A crosshead assembly in conjunction with a Stirling engine is disclosed. The assembly comprises a displacer piston (1), displacer rod (8), power piston (2), power piston crosshead assembly (2), displacer piston crosshead assembly (7), displacer crosshead connecting rod (6) and power crosshead connecting rod (5). In order to achieve a compact design, the displacer crosshead (7) and the power crosshead (2) are placed concentrically in such a way that the displacer crosshead oscillates within or partly within the power crosshead.

### TECHNICAL FIELD OF THE INVENTION

The invention relates to concentric mounting of crossheads. The invention has particular applicability to Stirling engines.

### BACKGROUND OF THE INVENTION

Stirling engines offer advantages of multi-fuel capabilities (geothermal, solar, bio-, fossil- and nuclear fuel), very low NOₓ and HC emissions when burning fossil fuels, very high total efficiency (particularly when used with CHP), and very low maintenance compared to internal combustion engines.

The principle of operation of a Stirling engine can be described with reference to FIG. 1. A displacer (a) and power piston (b) reciprocate within a cylinder with a fixed charge of working gas (e.g. air, nitrogen, helium or hydrogen). The displacer and power piston are connected to a crankshaft (c) via crossheads, connecting rods (d) and wristpins. As the displacer (a) reciprocates, it displaces the working gas (usually nitrogen or helium in production engines) through the heater head tubes (e), regenerator (f) and cooler (g) that are placed in the hot and cold portions of the engine. The displacer (a) and power piston (b) have different phase angles so that more work is put into the power piston during the expansion stroke, when most of the gas is in the hot space, than the work the piston returns to the gas a cycle later to compress cold gas back to the hot part of the engine. The net surplus of expansion work over compression work is extracted as useful work by the power piston, which in turn is transferred to the crankshaft (c) with its outgoing shaft. All external heat is supplied at the heater head (e) and rejected in the cooler (g). The regenerator (f) absorbs heat from the working gas as the gas moves from the hot end to the cold end. It returns the stored heat to the working gas when the gas is pushed from the cold end to the hot end. One can say that the regenerator acts as a “thermal dynamic sponge”.

In a β-type (or commonly called displacer type) engine, there is a power piston and displacer piston coaxially located within the same working cylinder. In order to move the displacer piston back and forth a displacer rod is coaxially positioned through the centre bore of the power piston. On the top side, the displacer rod is fastened to the displacer base which in turn can be threaded to the displacer piston (or dome). On the lower side, the displacer rod is fastened to the displacer crosshead.

Since a conventional β-type Stirling engine uses a crankshaft and connecting rod mechanism to transmit oscillating motion to rotary motion, there arises a need to accommodate side forces that originate during the Stirling cycle. In addition there is a need to permit the displacer rod to move freely within the oscillating assembly.

U.S. Pat. No. 4,711,091 shows an oil lubricated Stirling engine incorporating apparatus for preventing lubricating oil from rising through the cylinder of the engine and reaching the hot working space thereof. It specifically pertains to a displacer type Stirling engine (Beta type) having a power piston and a displacer coaxially disposed within the same cylinder. The specification also depicts a crosshead that takes up all side forces exerted by the power piston connecting rod assembly. The displacer is connected to a displacer rod that is coupled to a connecting rod with a wrist pin. All side forces from the displacer piston movement are transmitted to the linkage in the power connecting rod.

While the above mentioned arrangement may function satisfactorily in oil lubricated Stirling engines, it is too complicated and expensive to implement in non-lubricated Stirling engines. This arrangement also requires a height increase in a Stirling engine assembly, because the power crosshead must be located above the displacer linkage. In addition, there is no satisfactory solution for handling the side forces exerted by the displacer connection rod assembly.

In order to reduce the total height of the Stirling engine, it is an object of the present invention to provide a crosshead assembly where the displacer crosshead and power crosshead are positioned concentrically and in such a way that the displacer crosshead oscillates within or partly within the power crosshead.

It is another object of the invention to provide a crosshead assembly that is compact and permits a lower total building height.

### DISCLOSURE OF THE INVENTION

The invention provides an arrangement having a displacer piston, a displacer rod, a power piston, a displacer piston crosshead assembly, a power piston crosshead assembly, a displacer piston crosshead connecting rod and a power piston crosshead connecting rod, characterised in that the displacer piston crosshead assembly is disposed coaxially with respect to the power piston crosshead assembly, and the displacer piston crosshead assembly is located at least partly concentrically within the power piston crosshead assembly.

It is preferred that the displacer piston crosshead assembly is located wholly within the power piston crosshead assembly.

It is also preferred that the sliding surface length within the power piston crosshead assembly is longer than the sliding bearing length of the displacer piston crosshead assembly.

Alternatively it is preferred that the sliding surface length within the power piston crosshead assembly is shorter than the sliding bearing length of the displacer piston crosshead assembly.

The sliding bearing material may consist of a low friction PTFE with carbon or graphite fillers, or a polyamide such as Vespel™ or Meldin™.

The sliding bearing surfaces may have generally rectangular cross sections, or may be formed as a single cylindrical surface perpendicular to the circumference of the power piston cross head assembly or the displacer piston crosshead assembly, whereby side forces are reacted.

External surfaces of the power piston crosshead assembly which receive sliding bearing material may have stepped shoulders to retain that material

The invention includes a Stirling engine having an arrangement according to any one of the preceding paragraphs in the Disclosure of Invention.

### BRIEF DESCRIPTION OF THE DRAWINGS

FIG. 1 shows schematically a simplified Stirling engine.

FIG. 2 is a perspective view of the Oscillating assembly.

FIG. 3 is a side elevation of the Oscillating assembly.

FIG. 4 is a sectional view of the Oscillating assembly.

FIG. 5 is a perspective view of the power crosshead assembly.

FIG. 6 is a sectional view of the power crosshead assembly.

FIG. 7 is another sectional view of the power crosshead assembly.

FIG. 8 is a perspective view of the displacer crosshead assembly.

FIG. 9 is a sectional view of the displacer crosshead assembly.

FIG. 10 is two sectional views of the crosshead assemblies.

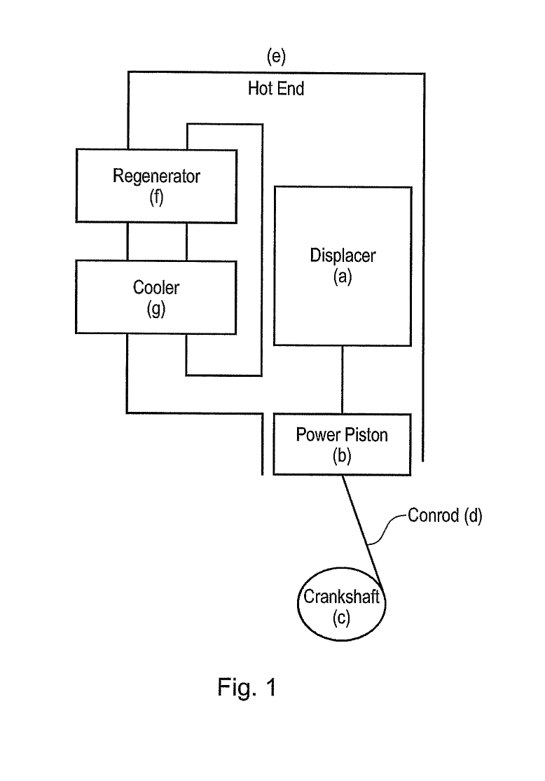

### DESCRIPTION OF A SPECIFIC EMBODIMENT OF THE INVENTION

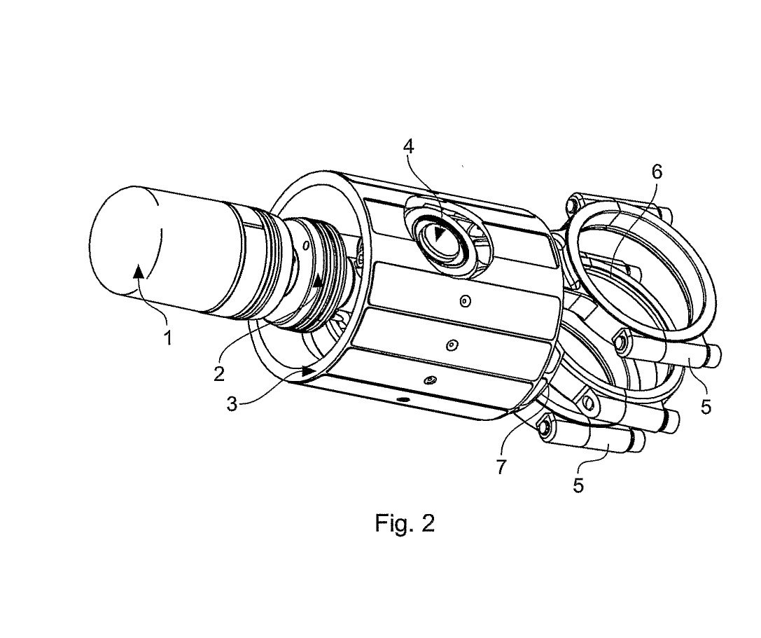

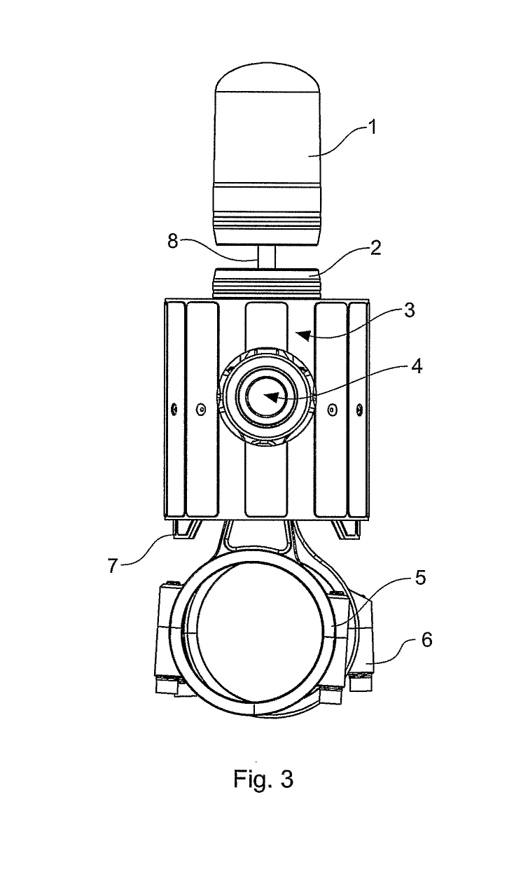

FIG. 2 is a perspective view of the oscillating assembly within a Stirling engine. Displacer piston 1 is shown with its sealing assembly. Said displacer piston 1 is fastened to a displacer rod (see FIG. 3, item 8). The displacer rod 8 is fastened to a power crosshead wrist pin 4 with needle bearings. The power crosshead wrist pin 4 is fixed to a power piston crosshead assembly 3.

Fixed to the power piston crosshead assembly 3 there are two power piston crosshead connecting rods 5. These connecting rods 5 are split, have roller bearings and are mounted on a traditional crankshaft (not shown).

The displacer rod (see FIG. 3, item 8) is concentrically placed with respect to the power piston 2 and the displacer piston 1. The displacer rod 8 is thereafter fastened to the displacer piston crosshead assembly 7. The displacer piston crosshead assembly 7 has its own wristpin with needle bearings, which in turn is fixed to the displacer piston crosshead connecting rod 6. The displacer connecting rod 6 is split, has a roller bearing and is mounted on the same crankshaft as the power connecting rods 5.

FIG. 3 is a side view of the oscillating assembly. All component numbers correspond to the component numbers designated in FIG. 2. In addition, the displacer rod 8 is clearly marked.

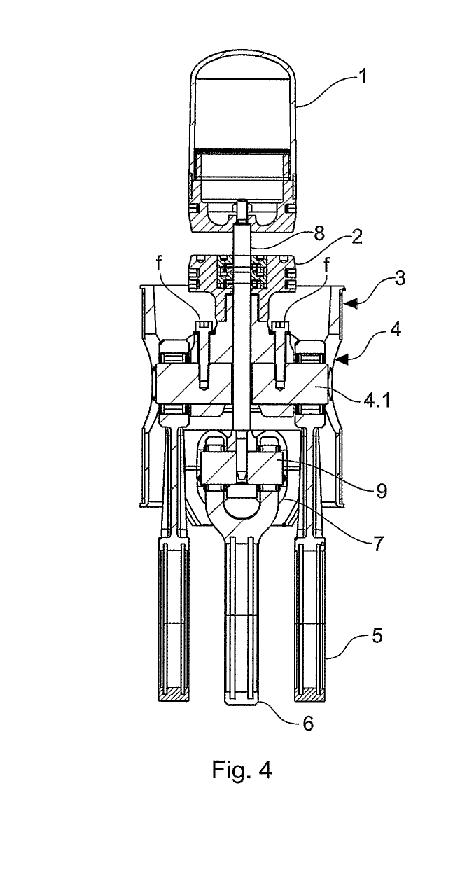

FIG. 4 is a cross sectional view of the oscillating assembly shown in FIG. 3. The displacer rod 8 is concentrically placed with respect to power piston 2 and power piston crosshead assembly 3. There is a clearance within the power piston 2 in order to allow free movement of the displacer rod 8. The displacer rod 8 is fastened to the displacer crosshead wristpin 9 by means of threaded engagement. The displacer crosshead wristpin 9 is fastened to the displacer piston crosshead connecting rod 6 by means of bearings e.g. needle type bearings.

Fasteners f are used to fix the power piston crosshead assembly 3 to the power crosshead wristpin 4.1. These fasteners prohibit the power crosshead wristpin 4.1 from rotating and damaging the displacer rod 8.

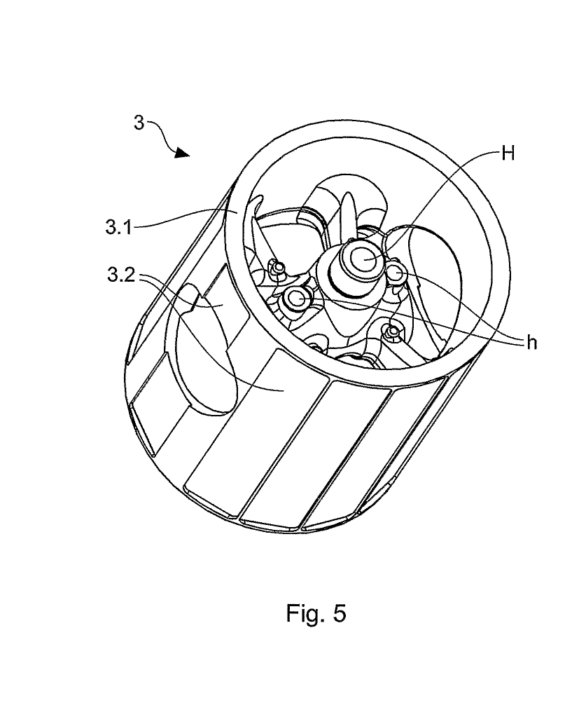

FIG. 5 is a perspective view of the power piston crosshead assembly 3. As shown in FIG. 2 this crosshead assembly 3 oscillates together with the power piston 2 and top portion of the power piston crosshead connecting rod 5. The power piston crosshead assembly 3 is placed concentrically within a cylinder (not shown for clarity reasons). The power piston crosshead assembly 3 is designed to take up all side forces that occur due to the combined oscillating and rotational motion of the power piston connecting rod 5. A hole H, concentrically placed in the power piston crosshead assembly 3 is provided to allow for the displacer rod 8 to pass through and connect to the displacer piston 1. Pockets 3.2 are machined (or can be cast) radially with a certain depth into the power piston crosshead assembly 3. These pockets receive wear pads or so called linear sliding bearings that are in contact with the working cylinder surface (not shown).

The pockets shown in FIG. 5 are rectangular in shape. Instead of a rectangular shape (time consuming and expensive to produce), they can be drilled or milled with a specific diameter (e.g. 15-25 mm) to a depth deep enough for the wear pads to be fitted and glued in place. If the casting process is accurate enough, it may be sufficient to cast the circular recess and avoid any machining. The number of linear sliding bearings 3.3 depends on the linear velocity, working pressure and side force.

Another possibility (not shown) is to have two circular bearings. Each of these would form the shape of an annulus, the outside diameter being slightly larger than the diameter of the cylinder it oscillates within, and the inside diameter being slightly smaller than the outside diameter of the power piston crosshead assembly 3. One of the bearings would be fastened (by adhesive or rivets) to the top part of the crosshead assembly 3, and the second bearing would be fastened to the bottom part of the crosshead assembly 3.

The power piston crosshead assembly 3 would have a step shape, with a shoulder to receive the bearings.

After fastening the bearings, the outside diameter would be turned or machined down to its final diameter in order to suit the cylinder within which the power piston crosshead assembly oscillates. Due to thermal expansion of the linear bearings, it may be preferable to split the annular bearing in four equal parts prior to fastening them on to the crosshead assembly.

The fabrication process of the power piston crosshead assembly 3 can be performed by sand casting, investment casting, die casting, forging or machined from a solid bar.

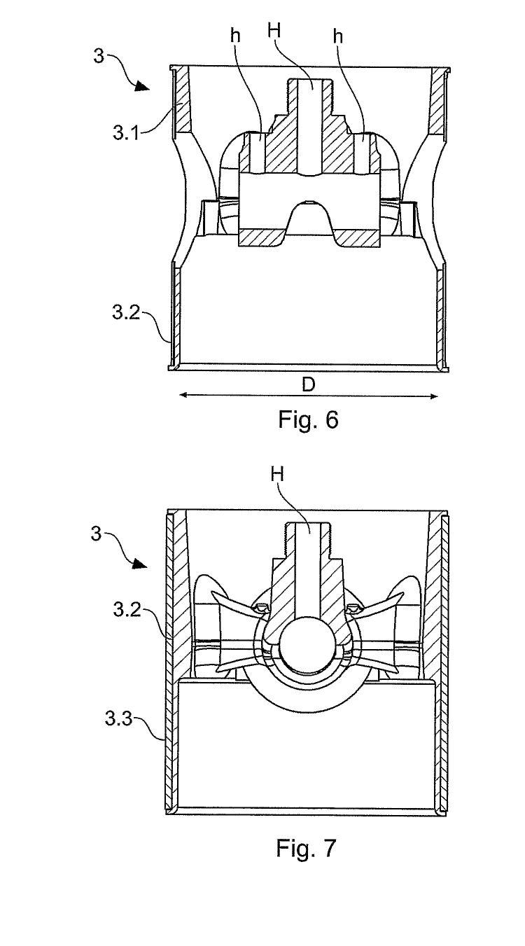

FIG. 6 is a sectional view of the power piston crosshead assembly 3 as shown in FIG. 5. The hole H for allowing the displacer rod 8 to pass through is clearly shown in this section. In addition, holes h are also shown. The holes h allow fasteners f (as shown in FIG. 4) to pass through and engage with the power crosshead wristpin 4.1. In this FIG. 6, two holes h are shown. It is clear that only one hole may be needed.

FIG. 7 is another sectional view of the power piston crosshead assembly 3. It is clear how the linear sliding bearings 3.3 are positioned within the crosshead pockets 3.2. These bearings can be glued, riveted or shrunk into the crosshead pockets 3.2. When the Stirling engine is operating these bearings slide against a cylinder (not shown) wherein the power crosshead is located within said cylinder. All side forces are thereby reacted by the linear sliding bearings 3.3.

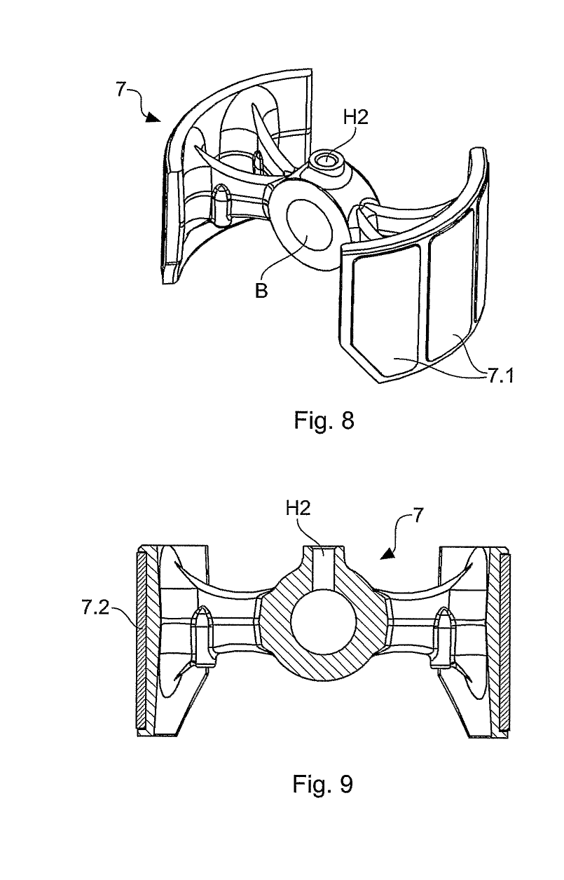

FIG. 8 is a perspective view of the displacer piston crosshead assembly 7. A concentric hole H2 is located in the crosshead centre body in order to permit the displacer rod 8 to be positioned concentrically through this hole. The displacer rod 8 can either be positioned within said hole by threaded engagement, or clearance can be provided between the outer diameter of the displacer rod 8 and diameter of hole H2. The displacer rod 8 can then be threaded directly in the displacer crosshead wristpin.

The displacer piston crosshead assembly 7 has a bore B to receive a displacer connecting rod wristpin (see FIG. 4, item 9). The displacer piston crosshead assembly 7 is also fitted with pockets 7.1 that are machined (or cast) radially with a certain depth into the assembly 7. The pockets 7.1 are dimentioned to accept sliding bearing plates 7.2. As shown these pockets are located in a circumferential manner on the outer surface of the displacer piston crosshead assembly 7. As shown in FIG. 8 there are six pockets on the outer surface. In other cases only four may be needed. The total number of sliding bearing plates 7.2 depends upon the application, revolutions, working pressure and of course side force. The fabrication process of the displacer piston crosshead assembly 7 can be performed by sand casting, investment casting, die casting, forging or machined from a solid bar.

The pockets shown in FIG. 8 are generally square or rectangular in shape. Instead of a rectangular shape (time consuming and expensive) they can be drilled or milled with a specific diameter (e.g. 15-25 mm) to a depth deep enough for wear pads to be fitted and glued in place. If the casting process is accurate enough it can be sufficient to create the circular recess and avoid any machining. The number of sliding bearing plates 7.2 depends upon the linear velocity, working pressure and side force.

FIG. 9 is a sectional view of the displacer piston crosshead assembly 7 as shown in FIG. 8. Here it is clearly shown how the bearing plates 7.2 are located within the assembly 7. As mentioned previously these bearings can be glued, riveted or shrunk into the displacer piston crosshead pockets 7.1. After the application procedure, the outer diameter is turned or machined to its final diameter.

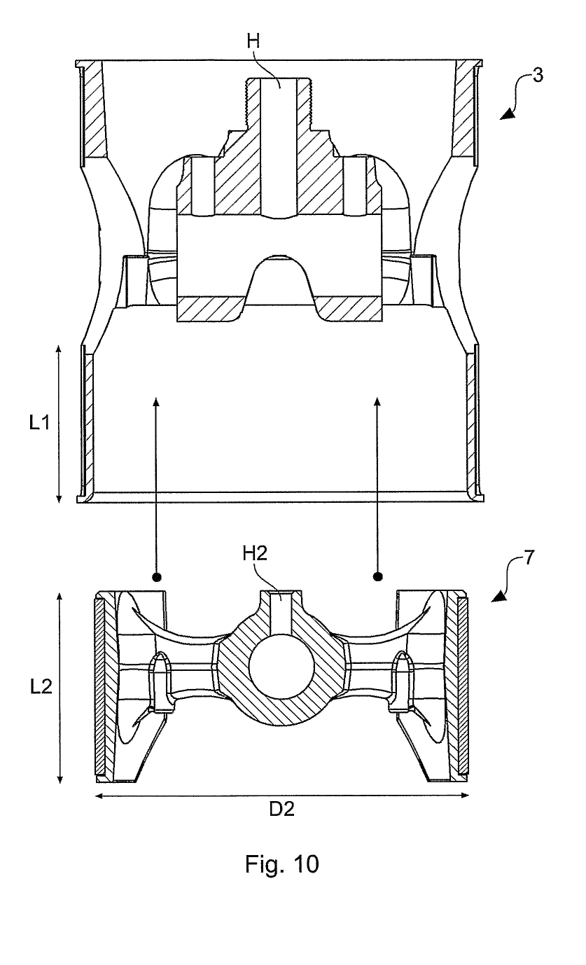

FIG. 10 is two sectional views of the crosshead assemblies 3 and 7. This section clearly shows how the displacer crosshead fits into the power crosshead. The outer diameter D2 of the displacer piston crosshead assembly 7 is slightly smaller than the inner diameter D of the power piston crosshead assembly 3 (see FIG. 6). The displacer crosshead thereby oscillates within or partly within the power crosshead.

The surface of the inner diameter D acts as the sliding surface for the outer sliding bearing of the displacer crosshead. This surface is usually machined to a very fine surface finish and thereafter hardened (case, nitrided, carburised, puls plasma etc.) to allow for a lower wear rate on the said surface. The surface of the inner diameter D of the power crosshead assembly 3 acts as a guide surface for the displacer piston crosshead assembly 7. All side forces that result from the displacer piston crosshead assembly are taken up by the inner diameter D of the power crosshead assembly.

When the displacer piston crosshead assembly 7 is placed within the power piston crosshead assembly 3, the sliding surface L1 within the assembly 3 is larger than the height or length L2 of the sliding bearing of the assembly 7. When the displacer piston crosshead assembly 7 is placed partly within the power piston crosshead assembly 3, the sliding surface L1 within the power crosshead assembly 3 can be shorter than the height or length L2 of the sliding bearing of the displacer crosshead assembly 7.

The sliding bearings 3.3 and 7.2 can be of low friction PTFE compounds including carbon or graphite fillers, or a polyamide such as Vespel™ or Meldin™. The sliding bearings can be made by a direct forming process in order to reduced costs and to minimise waste of material.

It is clear from FIG. 10 and FIG. 3 that when the displacer piston crosshead assembly 7 is positioned within or partly within the power piston crosshead assembly 3, the total height of the Stirling engine is lower than a traditional β-type Stirling engine that has the crossheads positioned on top of each other.

1-9. (canceled)

10. An arrangement having a displacer piston, a displacer rod, a power piston, a displacer piston crosshead assembly, a power piston crosshead assembly, a displacer piston crosshead connecting rod and a power piston crosshead connecting rod, in which the displacer piston crosshead assembly is disposed coaxially with respect to the power piston crosshead assembly, and the displacer piston crosshead assembly is located concentrically and wholly within the power piston crosshead assembly.

11. An arrangement as claimed in claim 10, in which the sliding surface length within the power piston crosshead assembly is longer than the sliding bearing length of the displacer piston crosshead assembly.

12. An arrangement as claimed in claim 10, in which the sliding surface length within the power piston crosshead assembly is shorter than the sliding bearing length of the displacer piston crosshead assembly.

13. An arrangement as claimed in claim 10, in which the sliding bearing material comprises low friction PTFE compounds including carbon or graphite fillers

14. An arrangement as claimed in claim 10, in which the sliding bearing material comprises a polyamide.

15. An arrangement as claimed in claim 12, in which a surface in contact with the sliding bearing has a rectangular cross section, and is disposed perpendicular to the circumference of the power piston crosshead assembly or displacer piston crosshead assembly, whereby side forces are reacted.

16. An arrangement as claimed in claim 12, in which a surface in contact with the sliding bearing has a circular cross section, and is disposed perpendicular to the circumference of the power piston crosshead assembly or displacer piston cross head assembly, whereby side forces are reacted.

17. An arrangement as claimed in claim 10, in which external surfaces of the power piston crosshead assembly which receive sliding bearing material have stepped shoulders to retain that material.

18. A Stirling engine having an arrangement as claimed in claim 10.
